(19) United States
(12) Patent Application Publication
(10) Pub. No.: US 2012/0270966 A1
(43) Pub. Date: Oct. 25, 2012

(54) Composition based on natural rubber and a reinforcing inorganic filler comprising dihydrazide

(75) Inventors: Julien Thuilliez, La Roche - Blanche (FR); Stephanie De Landtsheer, Moscow (RU); Brigitte Chauvin, Chamalieres (FR)

(73) Assignees: Michelin Recherche et Technique S.A., Granges-Paccot (CH); Societe De Technologie Michelin, Clermont-Ferrand (FR)

(21) Appl. No.: 13/138,035

(22) PCT Filed: Dec. 22, 2009
(86) PCT No.: PCT/EP2009/067749

§ 371 Date: Jul. 12, 2012

(30) Foreign Application Priority Data
Dec. 23, 2008 (FR) 0858989

(51) Int. Cl. C08L 7/00; C08K 3/04; C08K 5/24; C08K 3/36

(52) U.S. Cl. 523/156; 524/192

(57) ABSTRACT

Reinforced rubber composition based on at least (a) an elastomeric matrix predominantly based on natural rubber, (b) a reinforcing filler predominantly based on an inorganic filler, (c) a coupling agent and (d) a dihydrazide compound corresponding to the following formula I:

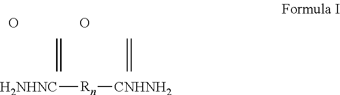

in which R is a divalent hydrocarbon radical chosen from aromatic radicals having from 6 to 20 carbon atoms or saturated or unsaturated aliphatic radicals having from 2 to 20 carbon atoms and n has the value 0 or 1. This rubber composition is intended, for example, for the manufacture of a semi-finished rubber product intended for the tires of motor vehicles.

The present invention relates to reinforced rubber compositions based on natural rubber, more than half the reinforcing filler of which is inorganic. These rubber compositions are intended, for example, for the manufacture of a semi-finished rubber product intended for the tires of motor vehicles.

It is known that, generally, in order to obtain optimum reinforcing properties conferred by a filler, it is advisable for the latter to be present in the elastomeric matrix in a final form which is both as finely divided as possible and as homogeneously distributed as possible. In point of fact, such conditions can only be achieved insofar as the filler exhibits a very good ability, on the one hand, to be incorporated in the matrix during the mixing with the elastomer and to deagglomerate and, on the other hand, to disperse homogeneously in this matrix. In an entirely known way, carbon black exhibits such abilities.

However, ever since savings in fuel and the need to protect the environment have become a priority, it has proved necessary to produce tires having a reduced rolling resistance without having a disadvantageous effect on their wear resistance. This has been made possible in particular by virtue of the use, in the rubber compositions, of specific inorganic fillers capable of competing, from a reinforcing viewpoint, with a conventional tire-grade carbon black, while giving these compositions a lower hysteresis, synonymous with a lower rolling resistance for the tires comprising them.

To further reduce the rolling resistance remains, in the current economic and ecological context, a permanent concern despite the low levels achieved with the specific inorganic fillers described as “reinforcing”. Numerous trials have already been explored in order to further lower the hysteresis of the rubber compositions reinforced with such fillers. Mention may be made, by way of example, of the modification of the structure of the diene polymers at the end of polymerization by means of functionalization, coupling or star-branching agents, with the aim of obtaining good interaction between the polymer thus modified and the reinforcing inorganic filler.

The inventors have discovered, during their research, that, in a rubber composition based on natural rubber as main elastomer and reinforced with an inorganic filler predominantly, the use of certain dihydrazide compounds makes it possible to significantly reduce the hysteresis of the composition. This reduction in the hysteresis in the proportions observed is unexpected, to say the least.

This is because hydrazides are known generally to lower the hysteresis of mixtures based on natural rubber comprising carbon black as sole or predominant reinforcing filler. By way of example, EP 0 738 754 A1 illustrates hybrid mixtures comprising carbon black as predominant filler, the reduction in the hysteresis losses of which is of the order of 8% after addition of dihydrazide compounds.

When an inorganic filler is used as sole or predominant reinforcing filler, relatively low hysteresis levels are already achieved. In point of fact, the inventors have demonstrated that the addition of a dihydrazide compound to a mixture based on natural rubber comprising silica as filler makes it possible not only to further lower the hysteresis level of this mixture but also to lower it in significant and unexpected proportions, much greater than those observed in the prior art for hybrid mixtures comprising carbon black as predominant reinforcing filler.

Given the significantly improved hysteresis properties of this composition based on natural rubber reinforced with an inorganic filler, the latter is particularly suitable for the manufacture of semi-finished rubber products intended for the tires of motor vehicles.

Thus, a subject-matter of the present invention is a reinforced rubber composition based at least on an elastomeric matrix comprising natural rubber, on a reinforcing filler comprising an inorganic filler according to a fraction by weight of more than 50%, with respect to the total weight of the filler, on a coupling agent and on a dihydrazide compound corresponding to the following formula I:

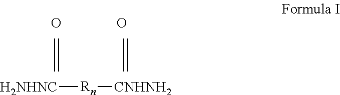

in which R is a divalent hydrocarbon radical chosen from substituted or unsubstituted aromatic radicals having from 6 to 20 carbon atoms or saturated or unsaturated and linear or branched aliphatic radicals having from 2 to 20 carbon atoms and n has the value 0 or 1.

Another subject-matter of the invention is a process for the preparation of such a reinforced rubber composition defined above.

Another subject-matter of the invention is a tire semi-finished rubber product composed, in all or part, of the reinforced rubber composition defined above.

Another subject-matter of the invention is a tire comprising at least one semi-finished rubber product composed, in all or part, of the reinforced rubber composition as defined above.

For greater clarity on reading that which will follow, the expression composition “based on” is understood to mean a composition comprising the mixture and/or the reaction product of the various constituents used, some of these base constituents being capable of reacting or intended to react with one another, at least in part, during the various phases of manufacture of the composition, in particular during the crosslinking or vulcanization thereof.

In the present description, unless expressly indicated otherwise, all the percentages (%) indicated are % by weight. Furthermore, any interval of values denoted by the expression “between a and b” represents the range of values extending from greater than a to less than b (that is to say, limits a and b excluded), whereas any interval of values denoted by the expression “from a to b” means the range of values extending from a up to b (that is to say, including the strict limits a and b). Furthermore, the amounts of the components of the invention can be expressed in phr, that is to say in parts (by weight) per 100 parts by weight of elastomer.

Thus, a first subject-matter of the invention is a reinforced rubber composition based at least (a) on an elastomeric matrix comprising at least natural rubber, (b) on a reinforcing filler composed to more than 50% by weight of an inorganic filler, (c) on a coupling agent and (d) on a dihydrazide compound corresponding to the following formula I:

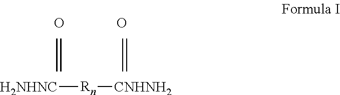

in which R is a divalent hydrocarbon radical chosen from substituted or unsubstituted aromatic radicals having from 6 to 20 carbon atoms or saturated or unsaturated and linear or branched aliphatic radicals having from 2 to 20 carbon atoms and n has the value 0 or 1.

Dihydrazide compounds are compounds described in the state of the art essentially for reducing the self-heating of rubber compositions. Mention may be made, for example, of EP 0 478 274 A 1. Dihydrazide compounds have also been used, in combination with various other compounds, in rubber compositions intended for tread manufacture. Thus, for example, EP 1 083 199 A 1 describes a tread composition comprising a dihydrazide compound in the presence of a bismaleimide in order to mitigate the negative effects of the latter on the properties of the rubber composition in which it is present. EP 0 761 733 A1 combines isophthalic dihydrazide with specific carbon blacks and functionalized SBR in tread compositions. EP 0 738 754 A1 combines isophthalic dihydrazide and isonicotinic hydrazide with a functionalized butyl polymer in a tread composition based on natural rubber.

According to the present invention, the dihydrazide compounds corresponding to the formula I are preferably chosen from those for which, in the formula I, R is a divalent hydrocarbon radical chosen from unsubstituted aromatic radicals having from 6 to 14 carbon atoms or saturated linear aliphatic radicals having from 3 to 12 carbon atoms.

More preferably, these dihydrazide compounds are chosen from phthalic dihydrazide, isophthalic dihydrazide, terephthalic dihydrazide, succinic dihydrazide, adipic dihydrazide, azelaic dihydrazide, sebacic dihydrazide, oxalic dihydrazide or dodecanedioic dihydrazide.

The rubber composition of the tire component according to the invention comprises the dihydrazide compound in an amount ranging from 0.25 to 7 phr, preferably from 0.3 to 2.5 phr and more preferably from 0.5 to 2 phr. The term “dihydrazide compound” according to the invention is understood to mean a compound or a mixture of several compounds of formula I.

The rubber composition according to the invention comprises at least four compounds, including also an elastomeric matrix.

According to the invention, the elastomeric matrix of the composition is based on natural rubber. In some cases, the elastomeric matrix can advantageously be entirely composed of natural rubber (100% of the elastomeric matrix is composed of natural rubber). This alternative form is particularly employed when it is a matter of using the rubber composition to manufacture treads for tires of utility vehicles, such as heavy-duty vehicles, or also some applications, such as ice or snow, of passenger vehicles, or also to manufacture metal reinforcement/rubber composites, such as, for example, crown or carcass plies.

The elastomeric matrix can also comprise, in addition to natural rubber, at least one other diene elastomer.

This or these other diene elastomers are then present in the matrix in proportions of between 0 and 50% by weight (the limits of this range being excluded), preferably between 5 and 40%, for example from 15 to 35%.

In the case of a blending with at least one other diene elastomer, the fraction by weight of natural rubber in the elastomeric matrix is predominant and preferably greater than or equal to 50% by weight of the total weight of the matrix, more preferably still between 60 and 95% by weight, for example from 65 to 85% by weight, of the total weight of the matrix.

Predominant fraction by weight according to the invention refers to the highest fraction by weight of the blend. Thus, in an NR/elastomer A/elastomer B blend, the fractions by weight can be distributed according to 40/40/20 or 40/30/30, the predominant fractions by weight being 40, and, in an NR/elastomer blend, the fractions by weight can be distributed according to 50/50 or 70/30, the predominant fractions by weight being 50 or 70.

The term “diene elastomer” should be understood according to the invention as meaning any functionalized natural rubber or any synthetic elastomer resulting at least in part from diene monomers. More particularly, the term “diene elastomer” is understood to mean any homopolymer obtained by polymerization of a conjugated diene monomer having from 4 to 12 carbon atoms or any copolymer obtained by copolymerization of one or more conjugated dienes with one another or with one or more vinylaromatic compounds having from 8 to 20 carbon atoms. In the case of copolymers, the latter comprise from 20 to 99% by weight of diene units and from 1 to 80% by weight of vinylaromatic units.

The functionalized natural rubber according to the invention is preferably an epoxidised natural rubber (ENR).

The diene elastomer constituting a portion of the elastomeric matrix according to the invention is preferably chosen from the group of highly unsaturated diene elastomers consisting of polybutadienes (BR), butadiene copolymers, polyisoprenes (PI), isoprene copolymers and the mixtures of these elastomers. Such copolymers are more preferably chosen from the group consisting of copolymers of butadiene and of a vinylaromatic monomer, more particularly the butadiene/stirene copolymer (SBR), isoprene/butadiene copolymers (BIR), copolymers of isoprene and of a vinylaromatic monomer, more particularly the isoprene/stirene copolymer (SIR), and isoprene/butadiene/stirene copolymers (SBIR). Particular preference is given, among these copolymers, to copolymers of butadiene and of a vinylaromatic monomer, more particularly the butadiene/stirene copolymer (SBR).

The diene elastomer constituting a portion of the elastomeric matrix according to the invention may or may not be star-branched, coupled or functionalized, in a way known per se, by means of functionalization, coupling or star-branching agents known to a person skilled in the art. Mention may be made, for example, among others more conventional, of the elastomers coupled according to the processes described in the patent applications on behalf of the Applicant Companies WO 08/141,702, FR 2 2910 64, FR 2 291 065 and FR 07/60442.

The rubber composition according to the invention comprises at least four compounds, including a reinforcing filler in proportions ranging from 35 to 200 phr. Preferably, the content of total reinforcing filler is between 40 and 140 phr, more preferably between 50 and 130 phr, the optimum being, in a known way, different according to the specific applications targeted for the tire; the expected level of reinforcement with regard to a bicycle tire, for example, is, of course, lower than that required with regard to a tire capable of running at high speed in a sustained manner, for example a motorcycle tire, a tire for a passenger vehicle or a tire for a utility vehicle, such as a heavy-duty vehicle.

According to the invention, the reinforcing filler is predominantly composed of a reinforcing inorganic filler, that is to say that the proportion of inorganic filler is greater than or equal to 50% by weight of the total weight of the filler, more particularly greater than 50%, up to a maximum of 100%. Preferably, the reinforcing filler is composed of 55 to 95% by weight of an inorganic filler.

The term “reinforcing inorganic filler” should be understood in the present patent application, by definition, as meaning any inorganic or mineral filler, whatever its colour or its origin (natural or synthetic), also known as “white filler”, “clear filler”, indeed even “non-black filler”, in contrast to carbon black, capable of reinforcing by itself alone, without means other than an intermediate coupling agent, a rubber composition intended for the manufacture of tires, in other words capable of replacing, in its reinforcing role, a conventional tire-grade carbon black; such a filler is generally characterized, in a known way, by the presence of hydroxyl (—OH) groups at its surface.

Preferably, the reinforcing inorganic filler is, completely or at the very least predominantly, silica (SiO₂). The silica used can be any reinforcing silica known to a person skilled in the art, in particular any precipitated or pyrogenic silica exhibiting a BET specific surface and a CTAB specific surface both of less than 450 m²/g, even if highly dispersible precipitated silicas are preferred. Mention will also be made, as reinforcing inorganic filler, of mineral fillers of the aluminous type, in particular alumina (Al₂O₃) or aluminium (oxide)hydroxides, or also reinforcing titanium oxides.

The physical state under which the reinforcing inorganic filler is provided is immaterial, whether in the powder, microbead, granule or bead form. Of course, the term “reinforcing inorganic filler” is also understood to mean mixtures of different reinforcing inorganic fillers, in particular of highly dispersible silicas as described above.

It should be noted that the reinforcing filler can comprise, as a blend (mixture), in addition to the abovementioned reinforcing inorganic filler or fillers, an organic filler, such as carbon black. This reinforcing organic filler is then preferably present according to a fraction by weight of less than 50%, with respect to the total weight of the filler.

All carbon blacks, in particular blacks of the HAF, ISAF, SAF, FF, FEF, GPF and SRF types, conventionally used in tire rubber compositions (“tire-grade” blacks) are suitable as carbon blacks. Mention will more particularly be made, among the latter, of the reinforcing carbon blacks of the 100, 200 or 300 series (ASTM grades), such as, for example, the N115, N134, N234, N326, N330, N339, N347 or N375 blacks, but also coarser blacks, such as, for example, the N550 or N683 blacks. The carbon blacks might, for example, be already incorporated in the natural rubber in the form of a masterbatch.

For example, the black/silica blends or the blacks partially or fully covered with silica are suitable for forming the reinforcing filler. Carbon blacks modified by silica, such as, without implied limitation, the fillers which are sold by Cabot under the name “CRX 2000”, and which are described in the international patent document WO-A-96/37547, are also suitable.

Mention may be made, as examples of organic fillers other than carbon blacks, of functionalized polyvinylaromatic organic fillers, such as described in Applications WO-A-2006/069792 and WO-A-2006/069793, or also of functionalized nonaromatic polyvinyl organic fillers, such as described in Applications WO-A-2008/003434 and WO-A-2008/003435.

In the case where the reinforcing filler comprises only a reinforcing inorganic filler and carbon black, the fraction by weight of this carbon black in the said reinforcing filler is more preferably chosen to be less than or equal to 30%, with respect to the total weight of the reinforcing filler.

The rubber composition according to the invention comprises at least four compounds, including a coupling agent for coupling the reinforcing inorganic filler to the natural rubber and to the optional diene elastomers of which the elastomeric matrix is composed.

The term “coupling agent” is understood to mean more specifically an agent capable of establishing a satisfactory connection of chemical and/or physical nature between the filler under consideration and the elastomer, while facilitating the dispersion of this filler in the elastomeric matrix. Such an at least bifunctional bonding agent has, for example, a simplified general formula, “Y-T-X′”, in which:
Y represents a functional group (“Y” functional group) which is capable of being bonded physically and/or chemically to the inorganic filler, it being possible for such a bond to be established, for example, between a silicon atom of the coupling agent and the surface hydroxyl (—OH) groups of the inorganic filler (for example the surface silanols, when silica is concerned);
X′ represents a functional group (“X′” functional group) capable of being bonded physically and/or chemically to the elastomer, for example via a sulphur atom;
T represents a divalent group which makes it possible to connect Y and X′. The bonding agents must not be confused with simple agents for covering the filler under consideration which, in a known way, can comprise the Y functional group active with regard to the filler but are devoid of the X′ functional group active with regard to the elastomer. Use may be made of any bonding agent known for or capable of efficiently providing, in the rubber compositions which can be used for the manufacture of tires, the bonding (or the coupling) between a reinforcing inorganic filler, such as silica, and a diene elastomer, such as, for example, organosilanes, in particular alkoxysilane polysulphides or mercaptosilanes, or polyorganosiloxanes carrying the abovementioned X′ and Y functional groups. Silica/elastomer bonding agents, in particular, have been described in a large number of documents, those well known being bifunctional alkoxysilanes, such as alkoxysilane polysulphides. Use is made in particular of silane polysulphides, known as “symmetrical” or “unsymmetrical” according to their specific structure, such as described, for example, in Applications WO 03/002648 (or US 2005/016651) and WO 03/002649 (or US 2005/016650).

Mention will more particularly be made, as examples of silane polysulphides, of bis(3-trimethoxysilylpropyl) or bis(3-triethoxysilylpropyl) polysulphides. Use is made in particular, among these compounds, of bis(3-triethoxysilylpropyl) tetrasulphide, abbreviated to TESPT, or bis(3-triethoxysilylpropyl) disulphide, abbreviated to TESPD. Mention will also be made, as preferred examples, of bis(mono(C₁-C₄)alkoxydi(C₁-C₄)alkylsilylpropyl) polysulphides (in particular disulphides, trisulphides or tetrasulphides), more particularly bis(monoethoxydimethylsilylpropyl) tetrasulphide, as described in Patent Application WO 02/083782 (or US 2004/132880).

Mention will in particular be made, as coupling agent other than alkoxysilane polysulphide, of bifunctional POSs (polyorganosiloxanes), or of hydroxysilane polysulphides, such as described in Patent Applications WO 02/30939 (or U.S. Pat. No. 6,774,255) and WO 02/31041 (or US 2004/051210), or of silanes or POSs carrying azodicarbonyl functional groups, such as described, for example, in Patent Applications WO 2006/125532, WO 2006/125533 and WO 2006/125534.

In the compositions in accordance with the invention, the content of coupling agent is advantageously less than 20 phr, it being understood that it is generally desirable to use as little as possible thereof. The content thereof is preferably between 0.5 and 12 phr, more preferably from 3 to 10 phr, in particular from 4 to 7 phr. This content is easily adjusted by a person skilled in the art according to the content of inorganic filler used in the composition.

The person skilled in the art will understand that use might be made, as filler equivalent to the reinforcing inorganic filler described in the present section, of a reinforcing filler of another nature, in particular organic nature, provided that this reinforcing filler is covered with an inorganic layer, such as silica, and which comprises, at its surface, functional sites, in particular hydroxyl sites, requiring the use of a coupling agent in order to establish the connection between the filler and the elastomer.

The rubber compositions in accordance with the invention can also comprise, in addition to coupling agents, coupling activators, agents for covering the inorganic fillers or more generally processing aids capable, in a known way, by virtue of an improvement in the dispersion of the filler in the rubber matrix and of a lowering in the viscosity of the compositions, of improving their ability to be processed in the raw state, these agents being, for example, hydrolysable silanes, such as alkylalkoxysilanes, polyols, polyethers, primary, secondary or tertiary amines, or hydroxylated or hydrolysable polyorganosiloxanes.

The rubber compositions in accordance with the invention can also comprise all or a portion of the usual additives generally used in elastomer compositions intended for the manufacture of tires, such as, for example, pigments, protection agents, such as antiozone waxes, chemical antiozonants or antioxidants, antifatigue agents, reinforcing or plasticizing resins, methylene acceptors (for example, phenolic novolak resin) or methylene donors (for example, HMT or H3M), such as described, for example, in Application WO 02/10269, a crosslinking system based either on sulphur or on sulphur donors and/or on peroxide and/or on bismaleimides, vulcanization accelerators, vulcanization activators, adhesion promoters, such as cobalt-based compounds, plasticizing agents, preferably nonaromatic or very slightly aromatic plasticizing agents chosen from the group consisting of nonpolar liquid plasticizers, such as naphthenic oils, paraffinic oils, MES oils or TDAE oils, polar liquid plasticizers, such as ether and ester plasticizers (for example, glycerol trioleates and more particularly oleic sunflower oil), and solid hydrocarbon resins exhibiting a high Tg, preferably of greater than 30° C., such as described, for example, in Applications WO 2005/087859, WO 2006/061064 and WO 2007/017060, and the mixtures of such compounds.

The invention also relates to a process for the preparation of a rubber composition as described above.

It should be pointed out that, according to the invention, the dihydrazide compound can be incorporated at any point in the process for the preparation of the rubber composition described above, including during the manufacture of the natural rubber on the site for the production thereof. The composition is manufactured in appropriate mixers using two successive preparation phases well known to a person skilled in the art: a first phase of thermomechanical working or kneading (phase referred to as “non-productive”) at high temperature, up to a maximum temperature of between 110° C. and 190° C., preferably between 130° C. and 180° C., followed by a second phase of mechanical working (phase referred to as “productive”) down to a lower temperature, typically of less than 110° C., for example between 40° C. and 100° C., finishing phase during which the crosslinking system is incorporated.

The process in accordance with the invention for preparing a rubber composition according to the invention comprises at least the following stages:
(i) carrying out, at a maximum temperature of between 130° C. and 200° C., preferably between 145° C. and 185° C., a first step of thermomechanical working (sometimes described as “non-productive” phase) of the necessary base constituents of the rubber composition, with the exception of the crosslinking system and, if appropriate, an adhesion promoter, by intimately incorporating, by kneading in one or more stages, ingredients of the composition in the elastomeric matrix based on natural rubber, then
(ii) carrying out, at a temperature lower than the said maximum temperature of the said first step, preferably of less than 120° C., a second step of mechanical working during which the said crosslinking system and, if appropriate, an adhesion promoter are incorporated.

The final composition thus obtained can subsequently be calendered, for example in the form of a sheet or of a plaque, or also extruded, for example in order to form a rubber profiled element which can be used as semi-finished rubber product intended for the tire. The dihydrazide compound corresponding to the formula I described above can thus be incorporated:
either as additive during the manufacture of the natural rubber on the site for the production thereof,
or as ingredient of the rubber composition according to the invention:
   during the preliminary preparation of a natural rubber/dihydrazide masterbatch on an open device of open mill type or on a closed device of internal mixer type,
   without preliminary preparation of a masterbatch, directly in the mixer during the first non-productive phase with the other compounds of the rubber composition.

This is why one alternative form of the process according to the invention comprises, prior to carrying out the abovementioned stage (i), the stages of the conventional manufacture of natural rubber which comprises the addition of the dihydrazide compound of formula I.

Another alternative form of the process according to the invention comprises, prior to carrying out the abovementioned stage (i), a stage of preparation of a masterbatch based on natural rubber and on the dihydrazide compound of formula I.

According to another alternative form of the process of the invention, all the base constituents of the composition of the invention, including the dihydrazide compound but with the exception of the vulcanization system, are incorporated during the first stage (i), the “non-productive” phase. Another subject-matter of the invention is a tire which incorporates, in at least one of its constituent components, a reinforced rubber composition according to the invention.

A subject-matter of the invention is very particularly a semi-finished rubber product, comprising a reinforced rubber composition according to the invention, intended for these tires.

Due to the reduced hysteresis which characterizes a reinforced rubber composition according to the invention, it should be noted that a tire having a tread comprising the composition exhibits an advantageously reduced rolling resistance.

Due to the reduced hysteresis which characterizes a reinforced rubber composition according to the invention, it should also be noted that a tire, all or part of the inner compositions of which comprise the composition of the invention, exhibits a significantly reduced self-heating and thus an improved endurance. The term “inner compositions” is understood to mean the compositions in contact with the textile or metal reinforcements of the tire and the compositions which are adjacent to them in the tire, apart from any composition in contact with the air or an inflation gas.

The tires in accordance with the invention are in particular intended for passenger vehicles as for industrial vehicles chosen from vans, heavy-duty vehicles, i.e. underground, bus, heavy road transport vehicles (lorries, tractors, trailers) or off-road vehicles, heavy agricultural vehicles or earth moving equipment, planes, and other transportation or handling vehicles.

The abovementioned characteristics of the present invention, and others, will be better understood on reading the following description of several implementational examples of the invention, given by way of illustration and without implied limitation.

Measurements and Tests Used

The rubber compositions are characterized before and after curing, as indicated below:

(a) the Mooney viscosity (ML 1+4) at 100° C.: measured according to Standard ASTM: D-1646, entitled “Mooney” in the tables; an increase in the relative value represents an increase in Mooney viscosity.
(b) the Shore A hardness: measurements carried out according to Standard DIN 53505; an increase in the relative value represents an increase in Shore A hardness.
(c) the Scott fracture index at 23° C.: the tensile strength (TS) is determined in MPa and the elongation at break (EB) is determined in %. All these tensile measurements are carried out under the standard conditions of temperature and humidity according to Standard ISO 37, an increase in the relative value representing an increase in the tensile strength and an increase in the elongation at break.
(d) the dynamic properties Delta G* and tan(δ)max are measured on a viscosity analyser (Metravib VA4000) according to Standard ASTM D 5992-96. The response of a sample of vulcanized composition (cylindrical test specimen with a thickness of 2 mm and with a cross section of 79 mm²), subjected to a simple alternating sinusoidal shear stress, at a frequency of 10 Hz, under the standard temperature conditions (23° C.) according to Standard ASTM D 1349-99, is recorded. A peak-to-peak strain amplitude sweep is carried out from 0.1 to 50% (outward cycle) and then from 50 to 0.1% (return cycle). The results made use of are the complex dynamic shear modulus (G*) and the loss factor tan δ. The maximum value of tan δ observed (tan(δ)max), and the difference in complex modulus (Delta G*) between the values at 0.1% and 50% strain (Payne effect), are shown for the return cycle. An increase in the relative value represents an increase in the value measured.

### EXAMPLE 1

### Compositions Comprising Either an Elastomer According to the Invention, or Elastomers not in Accordance with the Invention

### Incorporation of the Molecule

Several molecules of hydrazide type were used as additive for natural rubber:
terephthalic dihydrazide,
adipic dihydrazide,
dodecanedioic dihydrazide,
isophthalic dihydrazide,
hydroxynaphthoic monohydrazide,
blocked hydroxynaphthoic monohydrazide (BHM),
propionic monohydrazide,
benzhydrazide monohydrazide.

The molecules are represented in the following figures.

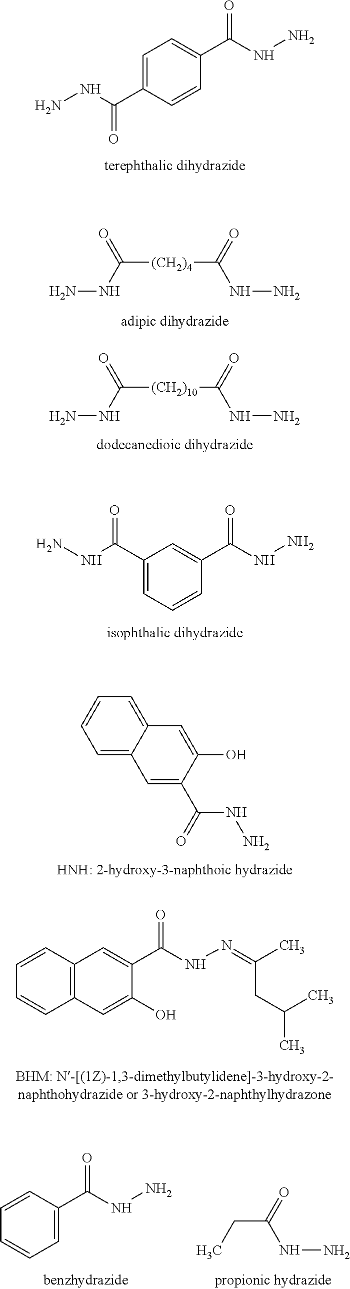

The method of incorporation of the molecule is as follows:

The natural rubber is subjected, on an open mill (temperature of the rolls regulated at 23° C.), the rolls of which have a diameter equal to 150 mm, an air gap equal to 2 mm and a rotational speed of the rolls of 20 revolutions/min, to the following stages:
1) 3 passes of the natural rubber initially at ambient temperature;
2) addition of a given amount of molecule in the powder form;
3) carrying out 12 passes so as to disperse the powder and to homogenize the sample.

Two different types of natural rubber were tested in order to form the masterbatches, an NR referenced TSR20 and an NR referenced TSR3L.

The breakdown is given in Table 1 below.

TABLE 1

| | | | Amount | Stage | | |
|---|---|---|---|---|---|---|
| Ref. | Type | Hydrazide | in phr | 1 | Stage 2 | Stage 3 |
| A | TSR20 | | | | | |
| B | TSR20 | | | X | | X |
| K | TSR20 | Terephthalic | 1 | X | X | X |
| L | TSR20 | Isophthalic | 1 | X | X | X |
| M | TSR20 | Adipic | 1 | X | X | X |
| N | TSR20 | Dodecanedioic | 1 | X | X | X |
| F | TSR3L | | | | | |
| G | TSR3L | | | X | | X |
| O | TSR3L | Terephthalic | 1 | X | X | X |
| P | TSR3L | Adipic | 1 | X | X | X |
| Q | TSR20 | Hydroxynaphthoic | 1 | X | X | X |
| R | TSR20 | BHM | 1 | X | X | X |
| S | TSR20 | Propionic | 1 | X | X | X |
| T | TSR20 | Benzhydrazide | 1 | X | X | X |

The propionic, HNH, BHM and benzhydrazide molecules are counterexamples (aliphatic, benzyl, naphthoic and blocked naphthoic monohydrazides).

Each of the compositions exhibits the following formulation (expressed in phr: parts per hundred parts of elastomer):

TABLE 1a

| | |
|---|---|
| Diene elastomer (1) | 100 |
| Hydrazide (Table 1) | 1 |
| Filler 1 (2) | 50 |
| Filler 2 (3) | 5 |
| Antioxidant (4) | 2.5 |
| Paraffin | 1 |
| Coupling agent (5) | 5 |
| Stearic acid | 2.5 |
| ZnO | 3 |
| Accelerator (6) | 1.8 |
| Sulphur | 1.5 |

(1) = Natural rubber
(2) = Silica, Zeosil 1165MP from Rhodia (BET and CTAB: approximately 160 m²/g)
(3) = Carbon black, N330
(4) = N-(1,3-Dimethylbutyl)-N′-phenyl-p-phenylenediamine
(5) = Coupling agent, TESPT (“Si69” from Degussa)
(6) = CBS (Santocure from Flexsys)

Each of the following compositions is produced, in a first step, by a thermomechanical working 10 and then, in a second finishing step, by a mechanical working.

The elastomer, the carbon black, ⅔ of the silica and the coupling agent are successively introduced into a laboratory internal mixer of “Banbury” type, the capacity of which is 400 cm³, which is 75% filled and which has a starting temperature of approximately 50° C. The final third of the silica, the stearic acid, the 6PPD and the paraffin at 90° C. The zinc oxide is introduced at 140° C.

The stage of thermomechanical working is carried out for 3 to 5 minutes, up to a maximum dropping temperature of approximately 165° C.

The first abovementioned step of thermomechanical working is thus carried out, it being specified that the mean speed of the blades during this first step is 70 rev/min.

The mixture thus obtained is recovered and cooled and then, in an external mixer (homofinisher), the sulphur and the sulphenamide are added at 30° C., the combined mixture being further mixed for a time of 3 to 4 minutes (second abovementioned step of mechanical working).

The compositions thus obtained are subsequently calendered, either in the form of plaques (with a thickness ranging from 2 to 3 mm) or fine sheets of rubber, for the measurement of their physical or mechanical properties.

The compositions thus obtained can also be extruded in the form of profiled elements which can be used directly, after cutting and/or assembling to the desired dimensions, for example as tire semi-finished products.

TABLE 1b

| | Composition | | | | | | | | | |
|---|---|---|---|---|---|---|---|---|---|---|
| | A | B | K | L | M | N | Q | R | S | T |
| Elastomer | A | B | K | L | M | N | Q | R | S | T |

Properties in the noncrosslinked state

| | | | | | | | | | | |
|---|---|---|---|---|---|---|---|---|---|---|
| MS 1 + 4 at 100° C. | 100 | 101 | 153 | 147 | 145 | 133 | 112 | 101 | 90 | 92 |
| (“Mooney mixture”) | | | | | | | | | | |

Properties in the crosslinked state

| | | | | | | | | | | |
|---|---|---|---|---|---|---|---|---|---|---|
| Shore A at 23° C. | 100 | 102 | 94 | 94 | 95 | 101 | 100 | 100 | 106 | 106 |

Scott fracture index at 23° C.

| | | | | | | | | | | |
|---|---|---|---|---|---|---|---|---|---|---|
| TS | 100 | 90 | 101 | 108 | 106 | 103 | 98 | 101 | 96 | 99 |
| EB (%) | 100 | 95 | 99 | 94 | 96 | 94 | 100 | 100 | 92 | 96 |

Dynamic properties as a function of the strain

| | | | | | | | | | | |
|---|---|---|---|---|---|---|---|---|---|---|
| Delta G* at 23° C. | 100 | 142 | 87 | 49 | 51 | 86 | 101 | 92 | 171 | 107 |
| Tap(δ) max at 23° C. | 100 | 112 | 90 | 65 | 71 | 84 | 99 | 93 | 113 | 99 |

It should be noted that the compositions K, L, M and N according to the invention exhibit a “Mooney mixture” value which is greater than that of the composition A based on unmodified NR, on the one hand, and higher than that of the composition B based on an NR merely worked on the device, on the other hand.

As regards the dynamic properties, it should be noted that the Delta G* and tan(δ)max values of the compositions K, L, M and N according to the invention are lower than those of the composition A based on an unmodified NR and lower than those of the composition B based on an NR merely passed over the device. The elastomers K, L, M and N comprising a terephthalic, isophthalic or aliphatic dihydrazide according to the invention make it possible to improve the hysteresis properties, with respect to the unmodified elastomer A and with respect to the elastomer B merely passed over the device without introduction of molecule.

In other words, the compositions K, L, M and N according to the invention based on NR comprising a terephthalic dihydrazide or an isophthalic dihydrazide or an adipic dihydrazide or a dodecanedioic hydrazide exhibit rubber properties in the crosslinked state which are improved, with respect to those of the composition A based on unmodified NR, due to a markedly reduced hysteresis.

The compositions Q, S and T not in accordance with the invention have Delta G* values which are greater than that of the composition A based on an unmodified NR. The compositions Q, S and T not in accordance with the invention have tan(δ)max values which are greater than or equivalent to that of the composition A based on an unmodified NR. The elastomers Q, S and T comprising a hydroxynaphthoic hydrazide or a propionic hydrazide or a benzhydrazide do not make it possible to improve the hysteresis properties, with respect to the unmodified elastomer A.

It should be noted that the Delta G* and tan(δ)max values of the composition R not in accordance with the invention are lower than those of the composition A based on an unmodified NR.

However, the Delta G* and tan(δ)max values of the compositions K, L, M and N according to the invention are lower than those of the composition R based on an NR comprising a hydroxy-naphthylhydrazone (BHM). In other words, the compositions K, L, M and N according to the invention exhibit rubber properties in the crosslinked state which are improved, with respect to those of the composition R based on BHM.

TABLE 1c

| Composition | F | G | O | P |
|---|---|---|---|---|
| Elastomer | F | G | O | P |

Properties in the noncrosslinked state

| | | | | |
|---|---|---|---|---|
| MS 1 + 4 at 100° C. | 100 | 101 | 141 | 138 |
| (“Mooney mixture”) | | | | |

Properties in the crosslinked state

| | | | | |
|---|---|---|---|---|
| Shore A at 23° C. | 100 | 98 | 94 | 96 |

Scott fracture index at 23° C.

| | | | | |
|---|---|---|---|---|
| TS | 100 | 102 | 103 | 106 |
| EB (%) | 100 | 97 | 97 | 91 |

Dynamic properties as a function of the strain

| | | | | |
|---|---|---|---|---|
| Delta G* at 23° C. | 100 | 113 | 56 | 44 |
| Tan(δ)max at 23° C. | 100 | 106 | 80 | 70 |

It should be noted that the compositions O and P according to the invention exhibit a “Mooney mixture” value which is greater than that of the composition F based on an unmodified NR, on the one hand, and higher than that of the composition G based on an NR merely worked on the device, on the other hand.

As regards the dynamic properties, it should be noted that the Delta G* and tan(δ)max values of the compositions O and P according to the invention are lower than those of the composition F based on an unmodified NR and those of the composition G based on an NR merely passed over the device. The elastomers O and P comprising a terephthalic or adipic dihydrazide according to the invention make it possible to improve the hysteresis properties, with respect to the unmodified elastomer F and with respect to the elastomer G merely passed over the device without introduction of molecule.

In other words, the compositions O and P according to the invention based on NR comprising a terephthalic dihydrazide or an adipic dihydrazide exhibit rubber properties in the crosslinked state which are improved, with respect to those of the composition F based on unmodified NR and on the composition G based on an NR merely worked on the device, on the other hand, as a result of a markedly reduced hysteresis.

### EXAMPLE 2

### Binary Blends of Elastomers

Each of these compositions exhibits the following formulation (expressed in phr: parts per hundred parts of elastomer):

TABLE 2a

| | | | |
|---|---|---|---|
| Diene elastomer (1) | 80 | 60 | 50 |
| Diene elastomer (2) | 20 | 40 | 50 |
| Hydrazide (Table 1) | 1 | 1 | 1 |
| Filler 1 (3) | 50 | 50 | 50 |
| Filler 2 (4) | 5 | 5 | 5 |
| Antioxidant (5) | 2.5 | 2.5 | 2.5 |
| Paraffin | 1 | 1 | 1 |
| Coupling agent (6) | 5 | 5 | 5 |
| Stearic acid | 2.5 | 2.5 | 2.5 |
| ZnO | 3 | 3 | 3 |
| Accelerator (7) | 1.8 | 1.8 | 1.8 |
| Sulphur | 1.5 | 1.5 | 1.5 |

(1) = Natural rubber
(2) = SSBR with 26% stirene and 24% poly(1,2-butadiene) units
(3) = Silica, Zeosil 1165MP from Rhodia (BET and CTAB: approximately 160 m²/g)
(4) = Carbon black, N330
(5) = N-(1,3-Dimethylbutyl)-N′-phenyl-p-phenylenediamine
(6) = Coupling agent, TESPT (“Si69” from Degussa)
(7) = CBS (Santocure from Flexsys)

Each of the following compositions is produced, in a first step, by a thermomechanical working and then, in a second finishing step, by a mechanical working.

The elastomers, the carbon black, ⅔ of the silica and the coupling agent are successively introduced into a laboratory internal mixer of “Banbury” type, the capacity of which is 400 cm³, which is 75% filled and which has a starting temperature of approximately 50° C. The final third of the silica, the stearic acid, the 6PPD and the paraffin at 90° C. The zinc oxide is introduced at 140° C.

The stage of thermomechanical working is carried out for 3 to 5 minutes, up to a maximum dropping temperature of approximately 165° C.

The first abovementioned step of thermomechanical working is thus carried out, it being specified that the mean speed of the blades during this first step is 70 rev/min.

The mixture thus obtained is recovered and cooled and then, in an external mixer (homofinisher), the sulphur and the sulphenamide are added at 30° C., the combined mixture being further mixed for a time of 3 to 4 minutes (second abovementioned step of mechanical working).

The compositions thus obtained are subsequently calendered, either in the form of plaques (with a thickness ranging from 2 to 3 mm) or fine sheets of rubber, for the measurement of their physical or mechanical properties.

The compositions thus obtained can also be extruded in the form of profiled elements which can be used directly, after cutting and/or assembling to the desired dimensions, for example as tire semi-finished products.

TABLE 2b

| | Composition | | | | | |
|---|---|---|---|---|---|---|
| | U | X | V | Y | W | Z |
| Elastomer | A/SSBR | K/SSBR | A/SSBR | K/SSBR | A/SSBR | K/SSBR |
| | 80/20 | 80/20 | 60/40 | 60/40 | 50/50 | 50/50 |

Properties in the noncrosslinked state

| | | | | | | |
|---|---|---|---|---|---|---|
| ML 1 + 4 at 100° C. | 100 | 129 | 100 | 122 | 100 | 120 |
| (“Mooney mixture”) | | | | | | |

Properties in the crosslinked state

| | | | | | | |
|---|---|---|---|---|---|---|
| Shore A at 23° C. | 100 | 97 | 100 | 97 | 100 | 97 |

Scott fracture index at 23° C.

| | | | | | | |
|---|---|---|---|---|---|---|
| TS | 100 | 105 | 100 | 113 | 100 | 104 |
| EB | 100 | 97 | 100 | 105 | 100 | 101 |

Dynamic properties as a function of the strain

| | | | | | | |
|---|---|---|---|---|---|---|
| Delta G* at 23° C. | 100 | 72 | 100 | 90 | 100 | 97 |
| Tap(δ) max at 23° C. | 100 | 87 | 100 | 95 | 100 | 98 |

It should be noted that the compositions X, Y and Z based on SBR/NR according to the invention blend exhibit a “Mooney mixture” value which is greater than those of the compositions U, V and W based on an SBR/unmodified NR blend.

As regards the dynamic properties, it should be noted that the Delta G* and tan(δ)max values of the compositions X, Y and Z according to the invention are lower than those of the compositions U, V and W based on an SBR/unmodified NR blend.

The decrease in hysteresis of the compositions based on SBR/NR according to the invention blend is related to the amount of modified NR according to the invention in the blend; in other words, the decrease in hysteresis is more marked when the amount of NR according to the invention is higher in the blend.

### EXAMPLE 3

### Filler=(Silica/Carbon Black) Mixture

Each of these compositions exhibits the following formulation (expressed in phr: parts per hundred parts of elastomer):

TABLE 3a

| | | |
|---|---|---|
| Diene elastomer (1) | 100 | 100 |
| Hydrazide (Table 1) | 1 | 1 |
| Filler 1 (2) | 40 | 30 |
| Filler 2 (3) | 15 | 25 |
| Antioxidant (4) | 2.5 | 2.5 |
| Paraffin | 1 | 1 |
| Coupling agent (5) | 4 | 3 |
| Stearic acid | 2.5 | 2.5 |
| ZnO | 3 | 3 |
| Accelerator (6) | 1.8 | 1.8 |
| Sulphur | 1.5 | 1.5 |

(1) = Natural rubber
(2) = Silica, Zeosil 1165MP from Rhodia (BET and CTAB: approximately 160 m²/g)
(3) = Carbon black, N330
(4) = N-(1,3-Dimethylbutyl)-N′-phenyl-p-phenylenediamine
(5) = Coupling agent, TESPT (“Si69” from Degussa)
(6) = CBS (Santocure from Flexsys)

Each of the following compositions is produced, in a first step, by a thermomechanical working and then, in a second finishing step, by a mechanical working.

The elastomer, the carbon black, ⅔ of the silica and the coupling agent are successively introduced into a laboratory internal mixer of “Banbury” type, the capacity of which is 400 cm³, which is 75% filled and which has a starting temperature of approximately 70° C. The final third of the silica, the stearic acid, the 6PPD and the paraffin at 90° C. The zinc oxide is introduced at 140° C.

The stage of thermomechanical working is carried out for 3 to 5 minutes, up to a maximum dropping temperature of approximately 165° C.

The first abovementioned step of thermomechanical working is thus carried out, it being specified that the mean speed of the blades during this first step is 70 rev/min.

The mixture thus obtained is recovered and cooled and then, in an external mixer (homofinisher), the sulphur and the sulphenamide are added at 30° C., the combined mixture being further mixed for a time of 3 to 4 minutes (second abovementioned step of mechanical working).

The compositions thus obtained are subsequently calendered, either in the form of plaques (with a thickness ranging from 2 to 3 mm) or fine sheets of rubber, for the measurement of their physical or mechanical properties.

TABLE 3b

| Composition | AA | AC | AB | AD |
|---|---|---|---|---|
| Elastomer | A | K | A | K |
| Silica/black ratio | 40/15 | 40/15 | 30/25 | 30/25 |

Properties in the noncrosslinked state

| | | | | |
|---|---|---|---|---|
| ML 1 + 4 at 100° C. | 100 | 133 | 100 | 138 |
| (“Mooney mixture”) | | | | |

Properties in the crosslinked state

| | | | | |
|---|---|---|---|---|
| Shore A at 23° C. | 100 | 97 | 100 | 96 |

Scott fracture index at 23° C.

| | | | | |
|---|---|---|---|---|
| TS | 100 | 100 | 100 | 105 |
| EB | 100 | 98 | 100 | 98 |

Dynamic properties as a function of the strain

| | | | | |
|---|---|---|---|---|
| Delta G* at 23° C. | 100 | 87 | 100 | 84 |
| Tan(δ) max at 23° C. | 100 | 90 | 100 | 89 |

It should be noted that the compositions AC and AD based on NR according to the invention exhibit a “Mooney mixture” value which is greater than those of the compositions AA and AB based on an unmodified NR.

As regards the dynamic properties, it should be noted that the Delta G* and tan(δ)max values of the compositions AC and AD according to the invention with variable amounts of silica and black in the composition are lower than those of the compositions AA and AB based on an unmodified NR.

### EXAMPLE 4

### Extended Formulation

Each of these compositions exhibits the following formulation (expressed in phr: parts per hundred parts of elastomer):

TABLE 4a

| | C 1 | C 2 |
|---|---|---|
| Diene elastomer (1) | 100 | 100 |
| Hydrazide (Table 1) | 1 | 1 |
| Filler 1 (2) | 80 | 80 |
| Coupling agent (3) | 6.4 | 6.4 |
| Filler 2 (4) | 6 | 6 |
| Plasticizer (5) | 15 | — |
| Plasticizer (6) | — | 15 |
| Resin (7) | 15 | 15 |
| DPG (8) | 1.5 | 1.5 |
| ZnO | 2.5 | 2.5 |
| Stearic acid | 2 | 2 |
| Antiozone wax | 1.5 | 1.5 |
| Antioxidant (9) | 1.9 | 1.9 |
| Sulphur | 1.1 | 1.1 |
| Accelerator (10) | 2.0 | 2.0 |

(1) = Natural rubber
(2) = Silica, “Zeosil 1165MP” from Rhodia (BET and CTAB: approximately 160 m²/g)
(3) = Coupling agent, TESPT (“Si69” from Degussa)
(4) = Carbon black, N234 (ASTM grade)
(5) = MES oil (“Catenex SNR” from Shell)
(6) = Diisononyl 1,2-cyclohexanedicarboxylate (“Hexamoll DINCH” from BASF)
(7) = Polylimonene resin (“Dercolyte L120” from DRT)
(8) = Diphenylguanidine (Perkacit DPG from Flexsys)
(9) = N-(1,3-Dimethylbutyl)-N-phenyl-para-phenylenediamine (Santoflex 6-PPD from Flexsys)
(10) = CBS (Santocure from Flexsys)

Each of these following compositions is prepared, in a first step, by a thermomechanical working and then, in a second finishing step, by a mechanical working.

The elastomer, the carbon black, ⅔ of the silica, the coupling agent and the DPG are successively introduced into a laboratory internal mixer of “Banbury” type, the capacity of which is 400 cm³, which is 75% filled and which has a starting temperature of approximately 70° C. Approximately one minute later, the final third of the silica, the stearic acid, the 6PPD, the wax, the resin and the MES oil (composition C1) or the diisononyl 1,2-cyclohexanedicarboxylate (composition C2). The zinc oxide is introduced after mixing for approximately 3 min.

The stage of thermomechanical working is carried out for 3 to 5 minutes, up to a maximum dropping temperature of approximately 165° C.

The first abovementioned step of thermomechanical working is thus carried out, it being specified that the mean speed of the blades during this first step is 80 rev/min.

The mixture thus obtained is recovered and cooled and then, in an external mixer (homofinisher), the sulphur and the sulphenamide are added at 30° C., the combined mixture being further mixed for a time of 3 to 4 minutes (second abovementioned step of mechanical working).

The compositions thus obtained are subsequently calendered, either in the form of plaques (with a thickness ranging from 2 to 3 mm) or fine sheets of rubber, for the measurement of their physical or mechanical properties.

TABLE 4b

| | Composition C1 | | | | | | | |
|---|---|---|---|---|---|---|---|---|
| | AG | AJ | AK | AL | AQ | AR | AS | AT |
| Elastomer | A | L | M | N | Q | R | S | T |

Properties in the noncrosslinked state

| | | | | | | | | |
|---|---|---|---|---|---|---|---|---|
| MS 1 + 4 at 100° C. | 100 | 149 | 146 | 137 | 112 | 108 | 94 | 85 |
| (“Mooney mixture”) | | | | | | | | |

Properties in the crosslinked state

| | | | | | | | | |
|---|---|---|---|---|---|---|---|---|
| Shore A at 23° C. | 100 | 96 | 98 | 104 | 96 | 101 | 105 | 103 |

Scott fracture index at 23° C.

| | | | | | | | | |
|---|---|---|---|---|---|---|---|---|
| TS | 100 | 87 | 118 | 101 | 82 | 99 | 103 | 102 |
| EB | 100 | 95 | 96 | 94 | 100 | 94 | 91 | 98 |

Dynamic properties as a function of the strain

| | | | | | | | | |
|---|---|---|---|---|---|---|---|---|
| Delta G* at 23° C. | 100 | 79 | 73 | 92 | 105 | 95 | 124 | 108 |
| Tap(δ) max at 23° C. | 100 | 91 | 90 | 93 | 107 | 99 | 105 | 104 |

It should be noted that the compositions AJ, AK and AL according to the invention exhibit a “Mooney mixture” value which is greater than that of the composition AG based on an unmodified NR.

As regards the dynamic properties, it should be noted that the Delta G* and tan(δ)max values of the compositions AJ, AK and AL according to the invention are lower than those of the composition AG based on an unmodified NR. The elastomers L, M and N comprising an isophthalic or aliphatic dihydrazide according to the invention make it possible to improve the hysteresis properties, with respect to the unmodified elastomer A, in the composition C1.

In other words, the compositions AJ, AK and AL according to the invention based on NR comprising an isophthalic dihydrazide or an adipic dihydrazide or a dodecanedioic hydrazide exhibit rubber properties in the crosslinked state which are improved, with respect to those of the composition AG based on unmodified NR, as a result of a reduced hysteresis.

The compositions AQ, AS and AT not in accordance with the invention have Delta G* and tan(δ)max values which are greater than those of the composition AG based on an unmodified NR. The elastomers Q, S and T comprising a hydroxynaphthoic hydrazide or a propionic hydrazide or a benzhydrazide do not make it possible to improve the hysteresis properties, with respect to the unmodified elastomer A.

It should be noted that the Delta G* and tan(δ)max values of the composition AR not in accordance with the invention are also lower than those of the composition AG based on an unmodified NR. However, the Delta G* and tan(δ)max values of the compositions AJ, AK and AL according to the invention are lower than those of the compositions AQ, AR, AS and AT based on an NR comprising a hydroxynaphthoic hydrazide or a hydroxy-naphthylhydrazone (BHM) or a propionic hydrazide or a benzhydrazide. In other words, the compositions AJ, AK and AL according to the invention exhibit rubber properties in the crosslinked state which are improved, with respect to those of the compositions AQ, AR, AS and AT based on an NR comprising a hydroxynaphthoic hydrazide or a hydroxy-naphthylhydrazone (BHM) or a propionic hydrazide or a benzhydrazide.

TABLE 4c

| Composition C1 | AM | AO | AP |
|---|---|---|---|
| Elastomer | F | O | P |

Properties in the noncrosslinked state

| | | | |
|---|---|---|---|
| ML 1 + 4 at 100° C. | 100 | 125 | 136 |
| (“Mooney mixture”) | | | |

Properties in the crosslinked state

| | | | |
|---|---|---|---|
| Shore A at 23° C. | 100 | 97 | 95 |

Scott fracture index at 23° C.

| | | | |
|---|---|---|---|
| TS | 100 | 106 | 104 |
| EB (%) | 100 | 104 | 98 |

Dynamic properties as a function of the strain

| | | | |
|---|---|---|---|
| Delta G* at 23° C. | 100 | 70 | 64 |
| Tan (δ)max at 23° C. | 100 | 91 | 86 |

It should be noted that the compositions AO and AP according to the invention exhibit a “Mooney mixture” value which is greater than that of the composition AM based on an unmodified NR. As regards the dynamic properties, it should be noted that the Delta G* and tan(δ)max values of the compositions AO and AP according to the invention are lower than those of the composition AM based on an unmodified NR. The elastomers 0 and P comprising a terephthalic or adipic dihydrazide according to the invention make it possible to improve the hysteresis properties, with respect to the unmodified elastomer F.

In other words, the compositions AO and AP according to the invention based on NR comprising a terephthalic dihydrazide or an adipic dihydrazide exhibit rubber properties in the crosslinked state which are improved, with respect to those of the composition AM based on unmodified NR, as a result of a reduced hysteresis, in the composition C1.

TABLE 4d

| Composition C2 | AX | AY | AZ |
|---|---|---|---|
| Elastomer | A | K | M |
| | TSR20 | TSR20 | TSR20 |
| | | tere | adi |

Properties in the noncrosslinked state

| | | | |
|---|---|---|---|
| ML 1 + 4 at 100° C. | 100 | 123 | 130 |
| (“Mooney mixture”) | | | |

Properties in the crosslinked state

| | | | |
|---|---|---|---|
| Shore A at 23° C. | 100 | 99 | 98 |

Scott fracture index at 23° C.

| | | | |
|---|---|---|---|
| TS | 100 | 101 | 100 |
| EB (%) | 100 | 97 | 92 |

Dynamic properties as a function of the strain

| | | | |
|---|---|---|---|
| Delta G* at 23° C. | 100 | 82 | 68 |
| Tan(δ)max at 23° C. | 100 | 93 | 87 |

It should be noted that the compositions AY and AZ according to the invention exhibit a “Mooney mixture” value which is greater than that of the composition AX based on an unmodified NR. As regards the dynamic properties, it should be noted that the Delta G* and tan(δ)max values of the compositions AY and AZ according to the invention are lower than those of the composition AX based on an unmodified NR. The elastomers K and M comprising a terephthalic or adipic dihydrazide according to the invention make it possible to improve the hysteresis properties, with respect to the unmodified elastomer A.

In other words, the compositions AY and AZ according to the invention based on NR comprising a terephthalic dihydrazide or an adipic dihydrazide exhibit rubber properties in the crosslinked state which are improved, with respect to those of the composition AX based on unmodified NR, as a result of a reduced hysteresis, in the composition C2.

### EXAMPLE 5

### Method of Introduction of the Dihydrazide

Each of these compositions exhibits the following formulation (expressed in phr: parts per hundred parts of elastomer):

TABLE 5a

| | A | K and BA |
|---|---|---|
| Diene elastomer (1) | 100 | 100 |
| Dihydrazide (2) | | 1 |
| Filler 1 (3) | 50 | 50 |
| Filler 2 (4) | 5 | 5 |
| Antioxidant (5) | 2.5 | 2.5 |
| Paraffin | 1 | 1 |
| Coupling agent (6) | 5 | 5 |
| Stearic acid | 2.5 | 2.5 |
| ZnO | 3 | 3 |
| Accelerator (7) | 1.8 | 1.8 |
| Sulphur | 1.5 | 1.5 |

(1) = Natural rubber
(2) = Terephthalic dihydrazide
(3) = Silica, Zeosil 1165MP from Rhodia (BET and CTAB: approximately 160 m²/g)
(4) = Carbon black, N330
(5) = N-(1,3-Dimethylbutyl)-N′-phenyl-p-phenylenediamine
(6) = Coupling agent, TESPT (“Si69” from Degussa)
(7) = CBS (Santocure from Flexsys)

Each of the following compositions is produced, in a first step, by a thermomechanical working and then, in a second finishing step, by a mechanical working.

The elastomer and the terephthalic dihydrazide (for the composition BA), the carbon black, ⅔ of the silica and the coupling agent are successively introduced into a laboratory internal mixer of “Banbury” type, the capacity of which is 400 cm³, which is 75% filled and which has a starting temperature of approximately 50° C. The final third of the silica, the stearic acid, the 6PPD and the paraffin at 90° C. The zinc oxide is introduced at 140° C.

The stage of thermomechanical working is carried out for 3 to 5 minutes, up to a maximum dropping temperature of approximately 165° C.

The first abovementioned step of thermomechanical working is thus carried out, it being specified that the mean speed of the blades during this first step is 70 rev/min.

The mixture thus obtained is recovered and cooled and then, in an external mixer (homofinisher), the sulphur and the sulphenamide are added at 30° C., the combined mixture being further mixed for a time of 3 to 4 minutes (second abovementioned step of mechanical working).

The compositions thus obtained are subsequently calendered, either in the form of plaques (with a thickness ranging from 2 to 3 mm) or fine sheets of rubber, for the measurement of their physical or mechanical properties.

The compositions thus obtained can also be extruded in the form of profiled elements which can be used directly, after cutting and/or assembling to the desired dimensions, for example as tire semi-finished products.

TABLE 5b

| Composition | A | K | BA |
|---|---|---|---|
| Elastomer | A | K | A |

Properties in the noncrosslinked state

| | | | |
|---|---|---|---|
| ML 1 + 4 at 100° C. | 100 | 153 | 151 |
| (“Mooney mixture”) | | | |

Properties in the crosslinked state

| | | | |
|---|---|---|---|
| Shore A at 23° C. | 100 | 94 | 98 |

Scott fracture index at 23° C.

| | | | |
|---|---|---|---|
| TS | 100 | 101 | 103 |
| EB (%) | 100 | 99 | 95 |

Dynamic properties as a function of the strain

| | | | |
|---|---|---|---|
| Delta G* at 23° C. | 100 | 87 | 85 |
| Tan(δ)max at 23° C. | 100 | 90 | 86 |

It should be noted that the compositions K and BA according to the invention exhibit a “Mooney mixture” value which is greater than that of the composition A based on an unmodified NR.

As regards the dynamic properties, it should be noted that the Delta G* and tan(δ)max values of the compositions K and BA according to the invention are lower than those of the composition A based on an unmodified NR. The elastomers K comprising a terephthalic dihydrazide and A with the introduction of the terephthalic dihydrazide in the mixer according to the invention make it possible to improve the hysteresis properties, with respect to the unmodified elastomer A.

In other words, the compositions K and BA according to the invention based on NR comprising a terephthalic dihydrazide exhibit rubber properties in the crosslinked state which are improved, with respect to those of the composition A based on unmodified NR, as a result of a reduced hysteresis, (i) when the molecule is introduced into the NR before the preparation of the mixture (preparation of a masterbatch on the device) and (ii) when the molecule is introduced into the mixer during the preparation of the mixture.

### EXAMPLE 6

### Effect of the Content of Dihydrazide

Each of these compositions exhibits the following formulation (expressed in phr: parts per hundred parts of elastomer):

TABLE 6a

| | |
|---|---|
| Diene elastomer (1) | 100 |
| Adipic dihydrazide | variable |
| Filler 1 (2) | 50 |
| Filler 2 (3) | 5 |
| Antioxidant (4) | 2.5 |
| Paraffin | 1 |
| Coupling agent (5) | 5 |
| Stearic acid | 2.5 |
| ZnO | 3 |
| Accelerator (6) | 1.8 |
| Sulphur | 1.5 |

(1) = Natural rubber
(2) = Silica, Zeosil 1165MP from Rhodia (BET and CTAB: approximately 160 m²/g)
(3) = Carbon black, N330
(4) = N-(1,3-Dimethylbutyl)-N′-phenyl-p-phenylenediamine
(5) = Coupling agent, TESPT (“Si69” from Degussa)
(6) = CBS (Santocure from Flexsys)

| | | | Amount in | | | |
|---|---|---|---|---|---|---|
| Ref. | Type | Dihydrazide | phr | Stage 1 | Stage 2 | Stage 3 |
| A | TSR20 | | | | | |
| U | TSR20 | Adipic | 0.5 | X | X | X |
| V | TSR20 | Adipic | 2 | X | X | X |

The method of incorporation of the molecule is as follows:

The natural rubber is subjected, on an open mill (temperature of the rolls regulated at 23° C.), the rolls of which have a diameter equal to 150 mm, an air gap equal to 2 mm and a rotational speed of the rolls of 20 revolutions/min, to the following stages:
1) 3 passes of the natural rubber initially at ambient temperature;
2) addition of a given amount of molecule in the powder form;
3) carrying out 12 passes so as to disperse the powder and to homogenize the sample.

Each of the following compositions is produced, in a first step, by a thermomechanical working and then, in a second finishing step, by a mechanical working.

The elastomer, the carbon black, ⅔ of the silica and the coupling agent are successively introduced into a laboratory internal mixer of “Banbury” type, the capacity of which is 400 cm³, which is 75% filled and which has a starting temperature of approximately 50° C. The final third of the silica, the stearic acid, the 6PPD and the paraffin at 90° C. The zinc oxide is introduced at 140° C.

The stage of thermomechanical working is carried out for 3 to 5 minutes, up to a maximum dropping temperature of approximately 165° C.

The first abovementioned step of thermomechanical working is thus carried out, it being specified that the mean speed of the blades during this first step is 70 rev/min.

The mixture thus obtained is recovered and cooled and then, in an external mixer (homofinisher), the sulphur and the sulphenamide are added at 30° C., the combined mixture being further mixed for a time of 3 to 4 minutes (second abovementioned step of mechanical working).

The compositions thus obtained are subsequently calendered, either in the form of plaques (with a thickness ranging from 2 to 3 mm) or fine sheets of rubber, for the measurement of their physical or mechanical properties.

The compositions thus obtained can also be extruded in the form of profiled elements which can be used directly, after cutting and/or assembling to the desired dimensions, for example as tire semi-finished products.

TABLE 6b

| Composition | A | BB | BC |
|---|---|---|---|
| Elastomer | A | U | V |

Properties in the noncrosslinked state

| | | | |
|---|---|---|---|
| ML 1 + 4 at 100° C. | 100 | 120 | 136 |
| (“Mooney mixture”) | | | |

Properties in the crosslinked state

| | | | |
|---|---|---|---|
| Shore A at 23° C. | 100 | 98 | 107 |

Scott fracture index at 23° C.

| | | | |
|---|---|---|---|
| TS | 100 | 100 | 103 |
| EB | 100 | 94 | 82 |

Dynamic properties as a function of the strain

| | | | |
|---|---|---|---|
| Delta G* at 23° C. | 100 | 68 | 86 |
| Tan(δ)max at 23° C. | 100 | 90 | 77 |

It should be noted that the compositions BB and BC according to the invention exhibit a “Mooney mixture” value which is greater than that of the composition A based on an unmodified NR.

As regards the dynamic properties, it should be noted that the Delta G* and tan(δ)max values of the compositions BB and BC according to the invention are lower than those of the composition A based on an unmodified NR. The elastomers U and V comprising an adipic dihydrazide at different contents according to the invention make it possible to improve the hysteresis properties, with respect to the unmodified elastomer A.

In other words, the compositions BB and BC according to the invention based on NR comprising an adipic dihydrazide at different contents exhibit rubber properties in the crosslinked state which are improved, with respect to those of the composition A based on unmodified NR, as a result of a reduced hysteresis.

1. A reinforced rubber composition based at least (a) on an elastomeric matrix comprising natural rubber, (b) on a reinforcing filler, at least 50% by weight of the total weight of the reinforcing filler of which is composed of an inorganic filler, (c) on a coupling agent and (d) on a dihydrazide compound corresponding to the following formula I: 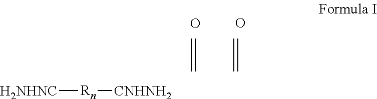
in which R is a divalent hydrocarbon radical chosen from substituted or unsubstituted aromatic radicals having from 6 to 20 carbon atoms or saturated or unsaturated and linear or branched aliphatic radicals having from 2 to 20 carbon atoms and n has the value 0 or 1.

2. The rubber composition according to claim 1, wherein the dihydrazide compound is present in a proportion ranging from 0.25 to 7 phr.

3. The rubber composition according to claim 1, wherein the fraction by weight of natural rubber in the elastomeric matrix is greater than or equal to 50% by weight of the total weight of the matrix.

4. The rubber composition according to claim 3, wherein the elastomeric matrix is 100% composed of natural rubber.

5. The rubber composition according to claim 1, wherein the reinforcing filler comprises a reinforcing inorganic filler in proportions ranging from 55 to 95% by weight of the total weight of the filler.

6. The rubber composition according to claim 1, wherein the inorganic filler is a silica.

7. The rubber composition according to claim 1, wherein the dihydrazide compound is chosen from phthalic dihydrazide, isophthalic dihydrazide, terephthalic dihydrazide, succinic dihydrazide, adipic dihydrazide, azelaic dihydrazide, sebbacic dihydrazide, oxalic dihydrazide or dodecanedioic dihydrazide.

8. A process for the preparation of a reinforced rubber composition as described in claim 1, comprising the steps of:
(i) carrying out, at a maximum temperature of between 130° C. and 200° C., a first step of thermomechanical working of the necessary base constituents of the rubber composition, with the exception of the crosslinking system and, if appropriate, of an adhesion promoter, by intimately incorporating, by kneading, ingredients of the composition in the elastomeric matrix based on natural rubber, then
(ii) carrying out, at a temperature lower than the said maximum temperature of the said first step, preferably of less than 120° C., a second step of mechanical working during which the said crosslinking system and, if appropriate, adhesion promoter are incorporated,
wherein, prior to carrying out the abovementioned stage (i), the process comprises the stages of the manufacture of natural rubber comprising a stage of addition of the dihydrazide compound of formula I.

9. A process for the preparation of a reinforced rubber composition tire component as described in claim 1, comprising the steps of:
(i) carrying out, at a maximum temperature of between 130° C. and 200° C., a first step of thermomechanical working (sometimes described as “non-productive” phase) of the necessary base constituents of the rubber composition, with the exception of the crosslinking system and, if appropriate, of an adhesion promoter, by intimately incorporating, by kneading, ingredients of the composition in the elastomeric matrix based on natural rubber, then
(ii) carrying out, at a temperature lower than the said maximum temperature of the said first step, preferably of less than 120° C., a second step of mechanical working during which the said crosslinking system and, if appropriate, the adhesion promoter are incorporated,
characterized in that, prior to carrying out the abovementioned stage (i), the process comprises a stage of preparation of a masterbatch based on natural rubber and on the dihydrazide compound of formula I.

10. A process for the preparation of a reinforced rubber composition tire component as described in claim 1, comprising the stages of:
(i) carrying out, at a maximum temperature of between 130° C. and 200° C., a first step of thermomechanical working (sometimes described as “non-productive” phase) of the necessary base constituents of the rubber composition, with the exception of the crosslinking system and, if appropriate, of an adhesion promoter, by intimately incorporating, by kneading, ingredients of the composition in the elastomeric matrix based on natural rubber, then
(ii) carrying out, at a temperature lower than the said maximum temperature of the said first step, preferably of less than 120° C., a second step of mechanical working during which the said crosslinking system and, if appropriate, adhesion promoter are incorporated,
wherein the dihydrazide compound of formula I is added to the mixture during stage (i).

11. A tire semi-finished rubber product, comprising a crosslinkable or crosslinked rubber composition according to claim 1.

12. The tire semi-finished product according to claim 11, wherein the product is a tread.

13. The tire semi-finished product according to claim 11, wherein the product is an inner composition.

14. A tire comprising a tire semi-finished product according to claim 11.
